(19) United States
(12) Patent Application Publication
(10) Pub. No.: US 2005/0253673 A1
(43) Pub. Date: Nov. 17, 2005

(54) Coaxial resonator

(76) Inventor: Peter Killer, Penzing (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 11/128,429

(22) Filed: May 13, 2005

(30) Foreign Application Priority Data
May 15, 2004 (DE) 10 2004 024 329.8

(51) Int. Cl. H01P 7/04

(52) U.S. Cl. 333/223; 333/234

(57) ABSTRACT

A coaxial resonator comprises a housing with walls which are metallically conductive at least on the inner side, with an injection and tapping opening and with a tube rejecting from a wall of the housing into its inner space, being metallically conductive and being conductively connected with said wall. The tube ends at a distance from the inner surface of the opposite wall and comprises a metallic tuning body which is axially displaceable. The risk that intermodulation products are produced which are caused by abraded parts produced during the displacement of the tuning body is prevented in such a way that the tuning body is held coaxially in the tube by way of a rod made of dielectric material, without contacting the tube conductively, and that the end of the rod averted from the tuning body is configured for displacing the tuning body.

### CROSS REFERENCE TO RELATED APPLICATIONS

This application claims priority under 35 U.S.C. §119 to German Application No. 10 2004 024 329.8 filed on May 15, 2004, entitled “A Coaxial Resonator,” the entire contents of which are hereby incorporated by reference.

### FIELD OF THE INVENTION

The invention relates to a coaxial resonator used with high frequency filters.

### BACKGROUND

Coaxial resonators typically include a common housing and inner spaces coupled to a multi-circuit, high-frequency filter. The housing of an individual resonator or a plurality of resonators is conductive, comprising metal with machined inner spaces and sealed by a metal cover. Alternatively, the conductive housing and/or cover may comprise plastic that is metal-coated along at least its interior (e.g., by electroplating). Similarly, the conductive tube of the resonator that projects into the inner space of the housing and serves as an interior conductor may comprise either metal or metal-coated plastic.

To tune such a resonator, one of three approaches is typically taken. First, the inner conductor of the resonator is opposed by a tuning screw, which is electrically connected with the resonator cover. Alternatively the tuning screw may be fastened into one the resonator walls. The tuning screw is positioned such that it penetrates the wall (usually the cover) and is equiaxial relative to the inner conductor. The resonance frequency can be altered simply by changing the immersion depth of the tuning screw into the HF space (i.e., the length that the screw extends into the interior space) until the desired resonator frequency is achieved. The inner conductor can also be configured in this case in a massive configuration instead of as a tube.

Second, instead of using a metallic tuning screw, a metal tuning pin may be used. The pin is contained in the inner conductor of the resonator and slides along metal bushings such that the length the pin extends into the resonator space can be adjusted. Adjusting the length the pin extends into the resonator space alters the resonator frequency.

Third, a dielectric material can be introduced into the resonator space, so that the resonance frequency changes. The dielectric also be introduced on either side of the inner conductor.

The above methods of tuning suffer from several disadvantages. Specifically, tuning using a dielectric only enables a narrow tuning range—the extent to which the resonance frequency of the coaxial resonator can be varied is limited. In addition, tuning via a screw or pin results in abrasion of the metal (or metal coating) comprising the housing, which can lead to intermodulation (IM) phenomena.

### OBJECTS AND SUMMARY

An object of the present invention is to address the above inefficiencies and provide a tuning variant and technique that allows shifting the resonance frequency of the coaxial resonator within a wide frequency range. At the same time, no metallic abrasion is produced, so that the IM stability is maintained at a high level.

This and other objects may be achieved using a coaxial resonator including a metallic tuning element (tuning slide) that can be axially displaced within a fixed inner conductor tube without metal contact (i.e., without contact between the tuning element and the conductor tube). The tuning element actuates via a non-conductive sliding member made of dielectric material (e.g., a ceramic rod) fastened to a threaded member that sits in a thread in the inner conductor tube.

The inner side of the inner conductor tube and the metallic tuning body form a coaxial conductor. The length of the inner conductor tube is dimensioned in such a way that it is equal to λ/4 at the desired resonance frequency. The opened end of the inner conductor tube therefore acts as a short circuit, so that at this location there is a contact between the inner conductor tube and the tuning body (which does not contact the inner conductor tube, so is ideal with respect to high-frequency). When the tuning body is displaced, the capacity between the face (free) side of the tuning body and the opposite wall of the housing is inversely proportional relative to the capacity between the jacket of the tuning body (positioned primarily between the portion of the tuning body enclosed by the tube) and the inner jacket of the tube. The resonance frequency changes according to this off-resonance setting of the resonator. The rod made of dielectric material, through which the tuning body is displaced, and the means for displacing the rod remain without any influence on the resonance frequency, because the tube serves as a round, hollow conductor partly filled with a dielectric, and whose critical frequency (as a result of the diameter) lies far above the resonance frequency, whose value is low with respect to the wavelength of the resonance frequency, so that the adjusting mechanism is unrelated to the frequency from the tuning body.

The method of adjusting the rod is not limited. For example, the rod can be guided in and out of the tube and the housing such that it can be displaced outside of the housing. In this case, a guide bushing or other guide means are necessary between the rod and the inner wall of the tube to ensure that the tuning body is displaceable in a precisely coaxial manner and has a constant width along an annular gap. The width of the annular gap may be small with respect to the inner wall of the tube into the same.

The end of the rod opposite the tuning body may be configured to engage an interior thread in the tube. The end of the rod may include an external thread configured to engage the tube thread. Alternatively, the end of the rod opposite the tuning body may sit in a bushing with an external thread configured to engage the internal thread in the tube.

The tuning body is advantageously comprises a U-shape, enclosing the end of the rod. The body can be fastened (e.g., by glue) to the end of the rod such that it extends along part of its depth or extends along the entire depth of the rod.

A dielectric such as air may situated between the tuning body and the inner wall of the tube (i.e., within the annular gap). In addition, the dielectric material may comprise plastic having a higher relative dielectric constant than air.

The rod may comprise ceramic material having various coefficients of thermal expansion. Since the rod is not situated in the field-filled space, it can also be made of plastic.

Appropriately, the tuning body and the rod comprise materials with temperature coefficients chosen so that the temperature-dependent change of the distance of the face surface of the tuning body from the inner surface of the housing wall compensates its temperature-dependent changes in dimension. The demand for stability of the tuning or resonance frequency can thus also be achieved over a large range of ambient temperatures.

### BRIEF DESCRIPTION OF THE DRAWINGS

The drawings show an embodiment of a connector in accordance with the invention in a schematic view and in a longitudinal sectional view, wherein like reference numerals in the various figures are utilized to designate like components, and wherein:

FIG. 1 illustrates a cross-sectional view of a resonator according to an embodiment of the invention.

FIG. 2 illustrates a top view of a resonator according to an embodiment of the invention with the housing cover removed.

### DETAILED DESCRIPTION

The resonator of the instant invention may comprise a resonator having a center or resonance frequency of 1750 MHz and a tuning range of 640 MHz. This type of resonator may be used in a four-circuit band filter for mobile radiotelephone service.

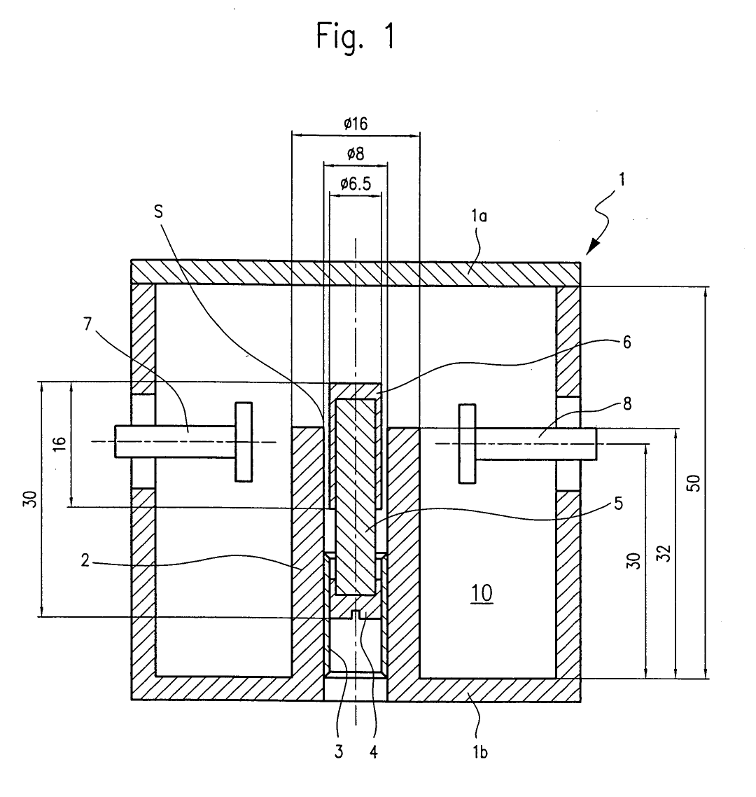

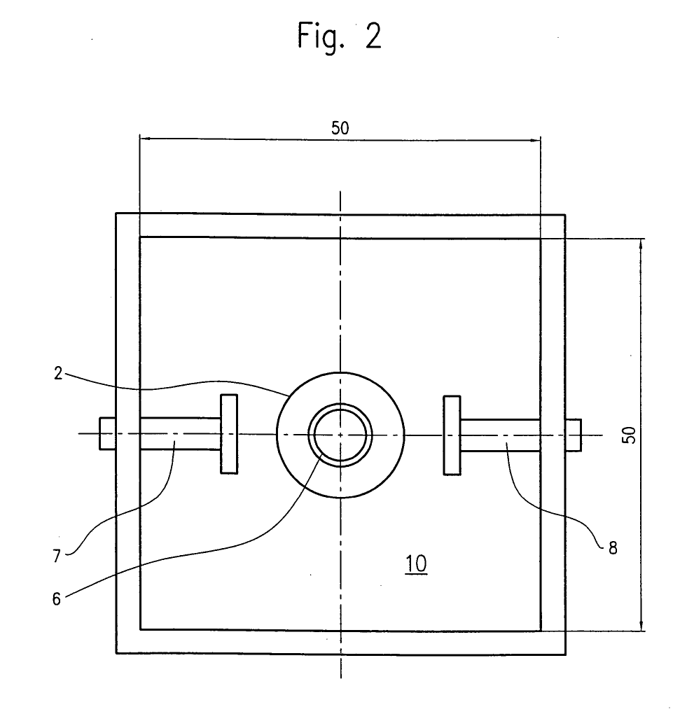

Referring to FIGS. 1 and 2, a resonator in accordance with the present invention may include a U-shaped conductive housing 1 (i.e., the housing is shaped like a pot having an open end and closed end). The material comprising the housing 1 is preferably metal. Alternatively, it may comprise metal-coated plastic. The geometry of the housing 1 may include, but is not limited to, a square shape. The housing may further comprise injection and tapping openings.

A cover 1a extends over the open end of the housing 1 to seal the housing and shield it from RF waves. The material comprising the cover 1a may be similar to the material comprising the housing 1. An inner tube 2 comprising conductive material (e.g., metal) may extend from the housing floor 1b (proximate its center) toward the cover 1a. This conductor tube 2 may extend from the floor 1b such that it creates a closed tube end (at the floor 1b) and an open tube end toward the cover 1a. The tube 2 can be made integral with the floor 1b (as shown in FIG. 1). The tube 2 includes an opening that defines a channel. A threaded collar 3 may be fastened (e.g., friction fit or an adhesive) into the channel of the tube 2, proximate the housing floor 1b (i.e., at the lower end of the tube).

A tuning screw 4 including a thread complementary to that of the collar 3 may connect to the threaded collar 3. A rod 5 comprising dielectric material (e.g., a ceramic rod) may be axially inserted into the tube, with the tuning screw 4 receiving the lower end of a rod 5.

A metal tuning body or element 6 may be positioned near the upper end of the rod 5. The tuning body 6 comprises an inverted U-shape that coaxially encloses the ceramic rod 5. The tuning body 6 may be positioned such that a portion of the ceramic rod 5 at least partially extends out of the upper end of the tube 2 (toward the cover 1a) and completely or partially into the tuning body 6. The upper surface of the tuning body forms a free face, wherein the distance between the face surface and the inner surface of the cover 1a may be altered by engaging the screw 4.

The tuning body 6 may comprise a generally cylindrical shape and be positioned within the tube 2 such that a substantially annular gap is formed. That is, the tuning body 6 does not touch the tube 2 or its inner wall at any location. Dielectric material such as air may be situated between the tuning body 6 and the inner wall of the tube 2. The width of the gap between the tuning body 6 and the tube 2 is not limited. By way of example the width of the air gap may be about 0.75 mm.

The length of the tube 2 may be λ/4 of the center frequency of the resonator. With this configuration, an RF short circuit is created at the open end of the tube 2, at the location S between the tuning body 6 and the tube 2 (FIG. 2). As a result, displacing the tuning body 6 by engaging the tuning screw 4 lengthens or a shortens the electrical length of the tube 2 to differentially change the capacity between the upper surface of the tuning body 6 and the cover 1a and the capacity between the jacket of the tuning body 6 and the inner wall of the tube 2. The housing defines and interior or inner space 10 having dimensions that determine the value of the center frequency of the resonator. The RF-energy may be injected inner space 10 using, for example, a conventional probe 8. Similarly, a probe 7 may be used to tap the RF energy.

The method of axial displacing the rod 5 is not limited. For example, the rod can be guided in and out of the tube and the housing such that it can be displaced outside of the housing. In this case, a guide bushing or other guide means are necessary between the rod and the inner wall of the tube 2 to ensure that the tuning body 6 is displaceable in a precisely coaxial manner and has a constant width along an annular gap. Alternatively, however, the end of the rod 5 opposite the tuning body 6 may engage an interior thread in the tube. Specifically, the end of the rod 5 opposite the tuning body 6 may be situated in a sleeve with an external thread configured to engage the internal thread of the tube 2. In addition, the end of the rod 5 opposite the tuning body 6 may sit in a bushing with an external thread configured to engage the internal thread of the tube.

With the above configuration, a change in resonator frequency can be caused by the following methods. First, the capacitance between tuning element 6 and the inner side of the inner conductor tube 2 forms a capacitive voltage divider with the head capacitance of the tuning element. Consequently, the total capacitance is changed following the axial displacement of the tuning element and the resonance frequency of the resonator also changes.

Second, if the length of the coaxial line formed by the inner side of the inner conductor tube 2 and the tuning element 6 is set to approximately a quarter-wave length (λ/4), a line is formed that is open at one end and (at the entrance (upper end) of the conductor tube 2) that has an input impedance of 0 ohms. When the tuning element 6 is displaced, the end capacitance of the inner conductor of the resonator also changes, changing the resonance frequency of the resonator.

Both solutions produce virtual contact between tuning element 6 and inner conductor tube 2 that is free from abrasion and eliminates any intermodulation effects. At the same time, this configuration represents a substantial simplification of the tuning apparatus.

Any influence on the quality of this virtual contact by the metallic adjusting mechanism can be excluded because annular gap is filled with air and non-conductive slide material is situated between the tuning element 6 and the thread. Essentially it creates a round, hollow conductor which is partly filled with a dielectric and whose critical frequency lies far above the intended operating frequency as a result of the small diameter. As a result, tuning element 6 and thread are fully uncoupled (separated) from each other with respect to high frequency. Furthermore, the frequency temperature compensation of the resonators can be achieved by a prudent choice of materials. That is, the tuning body and the rod may comprise materials with temperature coefficients chosen such that the temperature-dependent change of the distance of the face surface of the tuning body from the inner surface of the wall of the housing compensates its temperature-dependent change in dimension.

As a result of the proposed construction, the formation of intermodulation products is prevented by avoiding any metallic contact in the field-filled space, while providing large tuning ranges.

1. A coaxial resonator, comprsing:
a housing comprising conductive walls and interior dimensions tuned to a desired resonance frequency;
an injection and tapping opening;
a conductive tube projecting from a wall of the housing into an inner housing space, wherein the tube is conductively connected to the wall and wherein the tube terminates at a given distance from the inner surface of an opposing wall of the housing; and
a metal tuning body having a free face, the body being axially displaceable along said conductive tube to alter the distance between the free face and the inner surface of the opposite wall of the housing;
wherein the tuning body is secured coaxially within the tube by a rod comprising dielectric material such that the tuning body does not conductively contact the tube; and
wherein an end of the rod opposite the tuning body is configured to displace the tuning body.

2. A resonator according to claim 1, in which the end of the rod opposite the tuning body engages an internal thread in the tube.

3. A resonator according to claim 2, wherein the end of the rod opposite the tuning body is situated in a sleeve with an external thread configured to engage with the internal thread.

4. A resonator according to one of the claim 1, wherein the tuning body comprises a generally U-shaped structure enclosing the end of the rod.

5. A resonator according to one of the claim 1, wherein a dielectric is situated between the tuning body and the inner wall of the tube.

6. A resonator according to one of the claim 5, wherein the dielectric is air.

7. A resonator according to one of the claim 1 in which the rod comprises ceramic material.

8. A resonator according to one of the claim 1 in which the tuning body and the rod comprise materials with temperature coefficients chosen such that a temperature-dependent change of the distance of the free face surface of the tuning body from the inner surface of the opposite wall of the housing compensates the temperature-dependent change in dimension.

9. A resonator according to one of the claim 1, wherein the tube has a length of approximately λ/4 the center frequency of the resonator.
